(19) United States
(12) Patent Application Publication
(10) Pub. No.: US 2010/0181972 A1
(43) Pub. Date: Jul. 22, 2010

(54) Voltage regulator circuit

(75) Inventor: Hirokazu Kawagoshi, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/654,353

(22) Filed: Dec. 17, 2009

(30) Foreign Application Priority Data
Jan. 20, 2009 (JP) 2009-009491

(51) Int. Cl. G05F 1/571

(52) U.S. Cl. 323/269

(57) ABSTRACT

A voltage regulator circuit of the present invention includes an input circuit that inputs a voltage, an output circuit that outputs a voltage, a first differential amplifier that compares a predetermined reference voltage and a feedback voltage from the output circuit, a first transistor having a source connected to the input circuit, a drain connected to the output circuit, and a gate that inputs an output from the first differential amplifier, a second transistor having a source connected to the input circuit, a drain connected to the output circuit, a gate that inputs the output from the first differential amplifier, and a current driving capability that is less than the first transistor, and an overshoot adjusting circuit that turns off the first transistor if the feedback voltage exceeds a predetermined value.

### BACKGROUND

1. Field of the Invention

The present invention relates to a voltage regulator circuit for supplying a stable voltage to a load unit.

2. Description of Related Art

A logic control circuit used as a timing controller and a voltage regulator circuit used as a power supply thereof are built into an integrated circuit of an LCD (Liquid Crystal Display) controller driver for cellular phones, for example. The voltage regulator circuit outputs a constant voltage specified based on the withstand voltage performance of the logic control circuit. That is, the voltage regulator circuit is provided with a circuit for suppressing from generating a voltage that exceeds the constant voltage (overshoot).

Related arts according to the abovementioned voltage regulator circuit are described below. Japanese Unexamined Patent Application Publication No. 2007-219795 discloses a circuit that is provided with an output transistor connected between an input and an output terminal, a control transistor for turning off the output transistor, a voltage dividing resistor for dividing an output voltage to generate a first and a second divided voltage, a first differential amplifier for inputting the first divided voltage resistor and a reference resistor and driving the output transistor, and a second differential amplifier for inputting the second divided voltage and the reference voltage and driving the control transistor. Japanese Unexamined Patent Application Publication No. 2007-219795 discloses that this enables to eliminate a trim circuit and also a temperature fluctuation.

Japanese Unexamined Patent Application Publication No. 2007-11947 discloses a circuit that is provided with a P type MOSFET having an input power supply terminal connected to a source terminal and an output terminal connected to a drain terminal, a first and a second resistor connected between the output terminal and a ground terminal, a comparator for comparing a feedback voltage, which is obtained by dividing an output voltage of the output terminal by the first and the second resistor, with a reference voltage and changing a voltage to be input to a gate terminal of the P type MOSFET so that the feedback voltage matches the reference voltage. The circuit further includes an N type MOSFET that is connected in parallel with the P type MOSFET, turned off when the output voltage is at a predetermined voltage, and turned on when the output voltage is reduced. Japanese Unexamined Patent Application Publication No. 2007-11947 discloses that if a load current increases rapidly and the output voltage is reduced, the N type MOSFET is conducted to supply the load current, enabling to reduce the fluctuation of the output voltage.

However, in the circuit disclosed in Japanese Unexamined Patent Application Publication No. 2007-219795, if a comparator detects an overshoot, the output transistor is turned off and a current from the input terminal to the output terminal is completely blocked. This causes a problem that a load fluctuation on the output terminal cannot be handled. That is, in this configuration, if the output transistor is turned off, an operation of the feedback circuit composed of an operational amplifier and a resistor completely stops, and the output terminal cannot hold a voltage. Therefore, when the load applied to the output terminal suddenly changes after an overshoot is generated, the feedback circuit could repeat to return and stop.

FIG. 6 illustrates an operation waveform of the circuit according to a related art such as the one described above. FIG. 6 illustrates a control signal 30 to be input to the operational amplifier, an output voltage 31 output from the circuit, a reference voltage 32, an output (comparator output) 33 from the comparator, and a gate potential 34 of the output transistor. When the control signal 30 is turned on at a timing T1, the gate potential 34 changes to an ON side. When the output voltage 31 exceeds the reference voltage 32 at a timing T2, the comparator output 33 changes to a level voltage as at when the overshoot is generated, and the gate potential 34 changes to an OFF side. If a load is applied to the output terminal at a timing 3, the output voltage 31 is reduced below the reference voltage 32 instantaneously, the comparator output 33 changes to a level voltage as at when the overshoot is not generated, and the gate potential 34 changes to an ON side. Then, the feedback circuit returns, the output voltage 31 exceeds the reference voltage 32 again, and the feedback circuit repeats to return and stop. The present inventor has found a problem that this causes to oscillate the output voltage 31.

### SUMMARY

A first exemplary aspect of an embodiment of the present invention is a voltage regulator circuit that includes an input circuit that inputs a voltage, an output circuit that outputs a voltage, a first differential amplifier that compares a predetermined reference voltage and a feedback voltage from the output circuit, a first transistor having a source connected to the input circuit, a drain connected to the output circuit, and a gate that inputs an output from the first differential amplifier, a second transistor having a source connected to the input circuit, a drain connected to the output circuit, a gate that inputs the output from the first differential amplifier, and a current driving capability that is less than the first transistor, and an overshoot adjusting circuit that turns off the first transistor if the feedback voltage exceeds a predetermined value.

With the above aspect, when the overshoot is generated, the first output transistor is turned off by the overshoot adjusting circuit and the overshoot is eliminated. At this time, the second output transistor can maintain an ON state. A current driving capability (gate width) of the second output transistor is specified to be less than the first output transistor, and allow for an amount of current that will not directly influence the overshoot. This enables the output circuit to hold a predetermined voltage even when handling the overshoot. This voltage reduces a rapid voltage drop of the output circuit even if a load is applied to the output circuit when handling the overshoot and also suppresses an oscillation or the like of the output voltage, which is caused by a hunting of the first output transistor.

As described above, the present invention not only prevents the overshoot but also stabilizes the output voltage after the overshoot is generated.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 illustrates a basic configuration of a voltage regulator circuit according to the present invention;

FIG. 2 illustrates a basic configuration of the voltage regulator circuit according to a first exemplary embodiment of the present invention;

FIG. 3 illustrates an operation waveform of the voltage regulator circuit according to the first exemplary embodiment of the present invention;

FIG. 4 illustrates a basic configuration of a voltage regulator circuit according to a second exemplary embodiment of the present invention;

FIG. 5 illustrates an operation waveform of the voltage regulator circuit according to a third exemplary embodiment of the present invention; and

FIG. 6 illustrates an operation waveform of a voltage regulator circuit according to a related art.

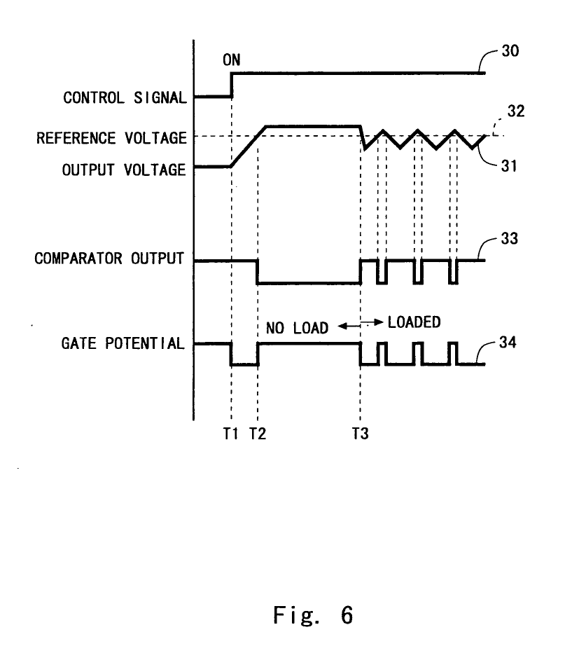

### DETAILED DESCRIPTION OF THE EXEMPLARY EMBODIMENTS

Exemplary embodiments of the present invention are described hereinafter with reference to the drawings. Note that in different exemplary embodiments, the components with the same or similar effects are denoted with the same symbol and the explanation thereof is omitted.

### First Exemplary Embodiment

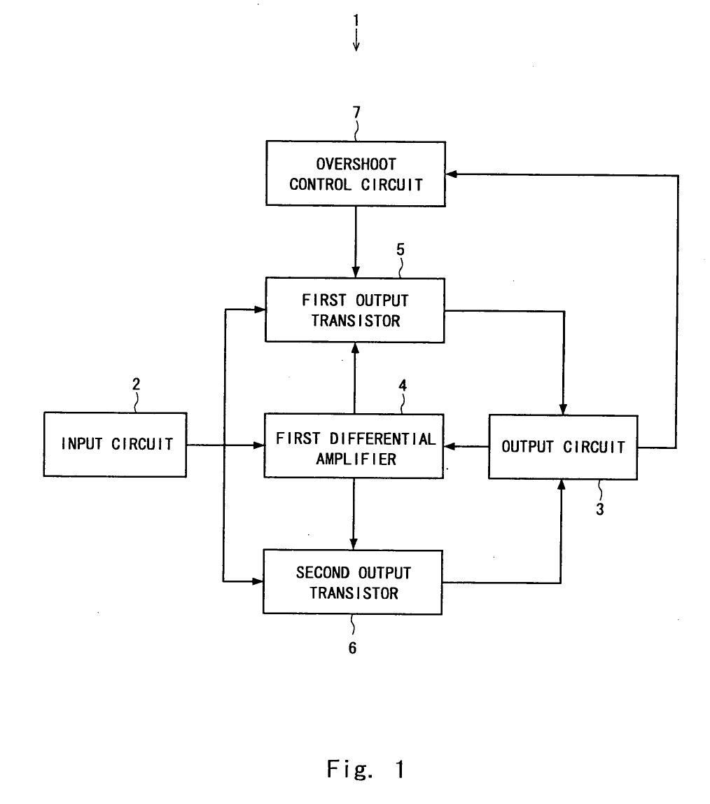

FIG. 1 illustrates a basic configuration of a voltage regulator circuit 1 according to the present invention. The voltage regulator circuit 1 includes an input circuit 2 for inputting a voltage, an output circuit 3 for outputting a voltage, a first differential amplifier 4 for comparing a predetermined reference voltage with a feedback voltage from the output circuit 3, a first transistor 5 having a source connected to the input circuit 2, a drain connected to the output circuit 3, and a gate inputting an output from the first differential amplifier 4, a second transistor 6 having a source connected to the input circuit 2, a drain connected to the output circuit 3, and a gate inputting an output from the first differential amplifier 4, and a current driving capability of the second transistor 6 is less than the first transistor 5, and an overshoot adjusting circuit 7 for turning off the first transistor 5 when the feedback voltage exceeds a predetermined value.

With the above configuration, when the overshoot is generated, the first output transistor 5 is turned off by the overshoot adjusting circuit 7 to eliminate the overshoot. At this time, the second output transistor 6 can maintain an ON state. The current driving capability (gate width) of the second output transistor 6 is specified to be less than the first output transistor 5, and also allow for an amount of current that will not directly influence the overshoot. This enables the output circuit 3 to hold a predetermined voltage even when handling the overshoot. This voltage enables to reduce a rapid voltage drop of the output circuit 3 even if a load is applied to the output circuit 3 when handling the overshoot, and also to suppress an oscillation or the like of an output voltage that is caused by a hunting of the first output transistor 14. That is, this not only prevents the overshoot but also stabilizes the output voltage after the overshoot is generated.

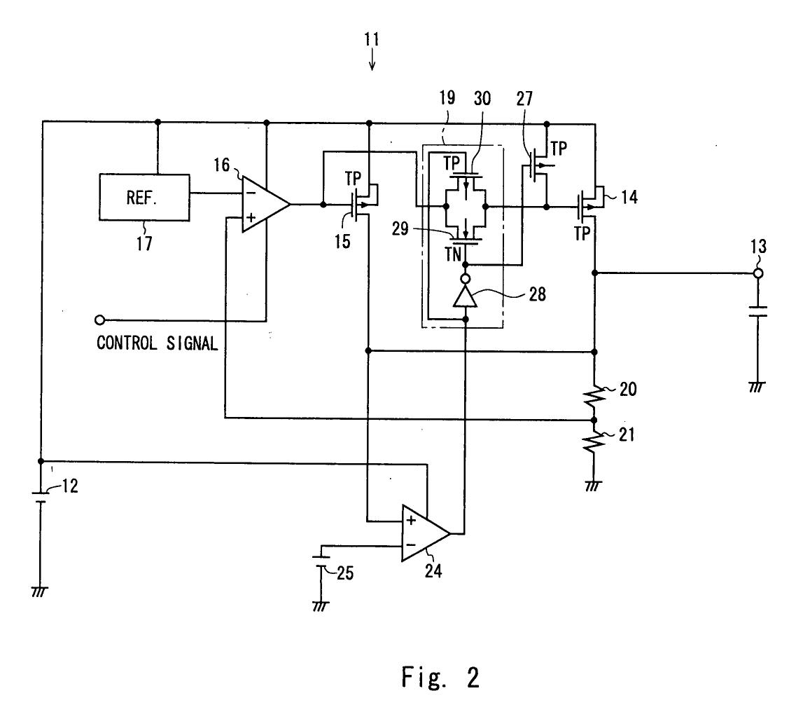

FIG. 2 illustrates the configuration of the voltage regulator circuit 11 according to the first exemplary embodiment. The voltage regulator circuit 11 is, for example, the one built into an integrated circuit for an LCD controller driver for cellular phones. The voltage regulator circuit 11 includes a direct current power supply 12, a pad 13, an operational amplifier 16, a first output transistor 14, a second output transistor 15, a comparator 24, a control transistor 27, and a switching circuit 19.

The operational amplifier 16 is the one well known in the art that amplifies a difference between the reference voltage and the feedback voltage, and outputs the amplified voltage. In the first exemplary embodiment, a minus side of a differential input terminal of the operational amplifier 16 is connected to the reference voltage circuit 17, and a plus side is connected to an intermediate point of the feedback resistor that is composed of two resistors 20 and 21.

The first output transistor 14 switches ON/OFF according to a feedback operation of the operational amplifier 16 and a detection operation of the overshoot by the comparator 24, which is described later. As for the first output transistor 14, a source is connected to the direct current power supply 12, a drain is connected to the pad 13, and a gate is connected to an output terminal of the operational amplifier 16 via the switching circuit 19 described later. Further, the first output transistor 14 is a PMOS transistor.

The second output transistor 15 switches ON/OFF according to a feedback operation by the operational amplifier 16. As for the second output transistor 15, a source is connected to the direct current power supply 12, a drain is connected to the pad 13, and a gate is connected to the output terminal of the operational amplifier 16. Further, the current driving capability (gate width) of the second output transistor 15 is specified to be less than the first output transistor 14. The second output transistor 15 is a PMOS transistor.

The comparator 24 is the one well known in the art that outputs an L or H level voltage according to the difference between the reference voltage and the feedback voltage. In this exemplary embodiment, a minus side of the differential input terminal of the comparator 24 is connected to a direct current power supply 25, and a plus side is connected to an intermediate point between the drain of the first output transistor 14 and the pad 13.

The control transistor 27 switches ON/OFF according to a detection operation of the overshoot by the comparator 24. As for the control transistor 27, a source is connected to the direct current power supply 12, a drain is connected to the gate of the first output transistor 14, and a gate is connected to the output terminal of the comparator 24 via an inverter 28. The control transistor 27 is a PMOS transistor. From this connection relationship, if the control transistor 27 is turned on, the first output transistor 14 is turned off. The control transistor 27 is turned on when an L level voltage is input to the gate, that is when an H level voltage is output from the comparator 24, in other words, when the overshoot is generated.

The switching circuit 19 is composed of the inverter 28, an NMOS transistor 29, and a PMOS transistor 30. A gate of the NMOS transistor 29 is connected to an output terminal of the inverter 28. A gate of the PMOS transistor 30 is connected to the output terminal of the comparator 24. Sources of the NMOS transistor 29 and the PMOS transistor 30 are connected to each other, and also connected to the output terminal of the operational amplifier 16. Drains of the NMOS transistor 29 and the PMOS transistor 30 are connected to each other, and also connected to the gate of the first output transistor and the drain of the control transistor 27. If an H level voltage is output from the comparator 24 by the switching circuit 19, that is when the overshoot is generated, an L level voltage is input to the gate of the control transistor 27 to be turned on, and the first output transistor 14 is turned off. Note that in this exemplary embodiment, although the above transfer switch is used as the switching circuit 19, the present invention is not limited to this but a circuit that achieves a similar effect can be used instead.

With the above configuration, when the comparator 24 outputs an H level voltage (when the overshoot is generated), the control transistor 27 is turned off and the first output transistor 14 is turned on. Then a current via the first output transistor 14 is blocked to eliminate the overshoot. At this time, the second output transistor 15 is controlled regardless of the output from the comparator 24, thus the second output transistor can maintain an ON state. This enables to supply a current to the pad 13 via the second output transistor 15 even when handling the overshoot. The current driving capability of the second output transistor 15 is specified (gate width is selected) so that the current flowing at this time will not directly influence the overshoot. By the current of the second output transistor 15, a voltage can be supplied to the pad 13 even when handling the overshoot. This voltage enables to reduce a rapid voltage drop of the pad 13 even if a load is applied to the pad 13 when handling the overshoot, and also to suppress an oscillation or the like of an output voltage that is caused by a hunting of the first output transistor 14.

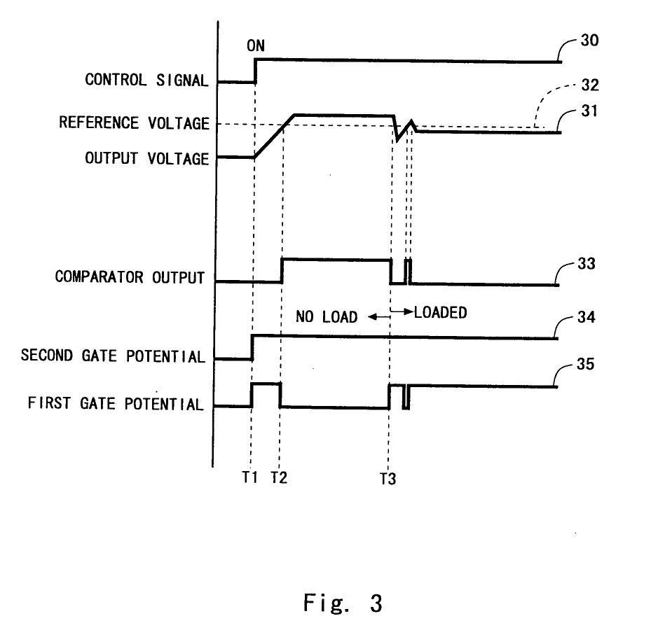

FIG. 3 illustrates an operation waveform of the voltage regulator circuit 11 with the above configuration. FIG. 3 illustrates a control signal 30 to be input to the operational amplifier 16, an output voltage 31 from the pad 13, a reference voltage 32 for determining a generation of the overshoot, an output (comparator output) 33 from the comparator 24, a gate potential 34 of the second output transistor 15 (a second gate potential), and a gate potential 35 (a first gate potential) of the first output transistor 14.

When the control signal 30 is turned on at a timing T1, the second gate potential 34 and the first gate potential 35 change to an ON side. When the output voltage 31 exceeds the reference voltage 32 at a timing T2, the comparator output 33 changes to a level voltage as at when the overshoot is generated and the first gate voltage 35 changes to an OFF side. A predetermined load is applied to the pad 13 at a timing T3. At this time, the output voltage 31 is reduced below the reference voltage 32 instantaneously, the comparator output 33 changes to a level voltage as at when the overshoot is not generated, and the first gate voltage 35 changes to an ON side. Along with this, the output voltage 31 is reduced below the reference voltage 32 instantaneously and the comparator output 33 and the first gate potential 35 follows the output voltage 31, however the second gate potential stays to be ON side from the beginning to end. Then the second output transistor 15 continues to supply power even after the overshot is generated and the voltage of the pad 13 is maintained. Accordingly, a rapid voltage drop of the pad 13 can be reduced even if a load is applied to the pad 13 when handling the overshoot and thereby enabling to stabilize the output voltage 31.

### Second Exemplary Embodiment

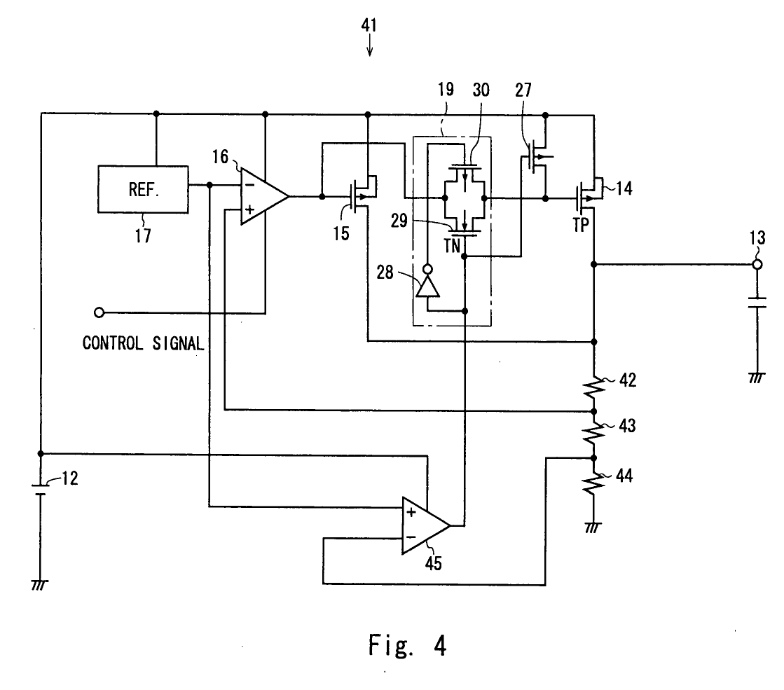

FIG. 4 illustrates the configuration of a voltage regulator circuit 41 according to a second exemplary embodiment of the present invention. The voltage regulator circuit 41 includes a feedback resistor which is composed of three resistances 42, 43, and 44. Then, a minus side of a differential input terminal of a comparator 45 is connected to an intermediate point between the resistances 43 and 44, and a plus side is connected to the reference voltage circuit 17. By using the intermediate point of the feedback resistor as the reference voltage of the comparator 45 in this way, circuit components such as a power supply device can be eliminated.

### Third Exemplary Embodiment

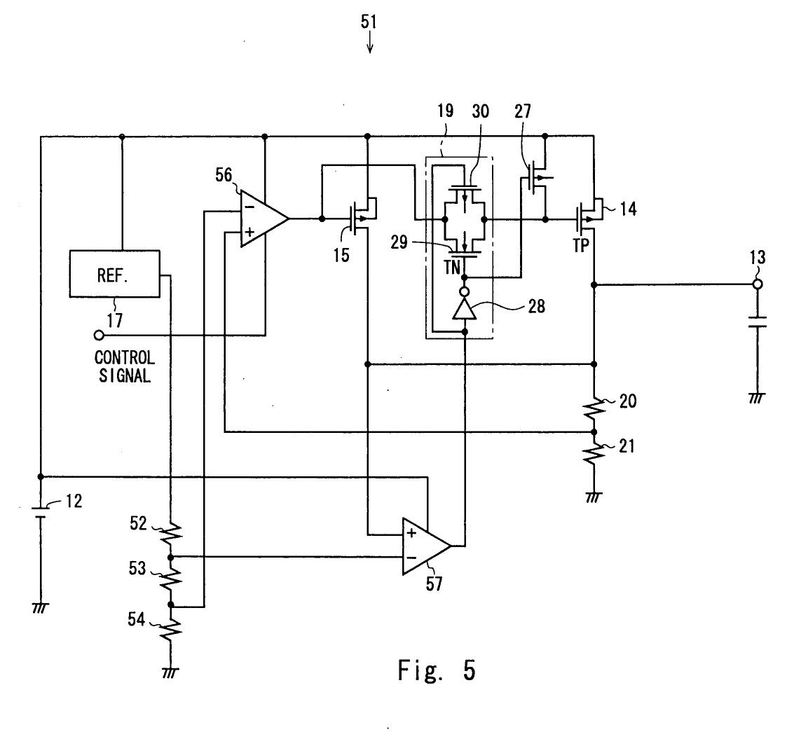

FIG. 5 illustrates the configuration of a voltage regulator circuit 51 according to a third exemplary embodiment of the present invention. In the voltage regulator circuit 51, three resistances 52, 53, and 54 are disposed in an output unit of the reference voltage circuit 17. Then, an intermediate point of these resistances 52, 53, and 54 is connected to a minus side of the differential input terminal of an operational amplifier 56, and also connected to a minus side of the differential input terminal of the comparator 57. By using the intermediate point obtained by dividing an output of one reference voltage circuit 17 as a reference voltage of the operational amplifier 56 and the comparator 57, the circuit components can be reduced.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A voltage regulator circuit comprising:
an input circuit that inputs a voltage;
an output circuit that outputs a voltage;
a first differential amplifier that compares a predetermined reference voltage and a feedback voltage from the output circuit;
a first transistor having a source connected to the input circuit, a drain connected to the output circuit, and a gate that inputs an output from the first differential amplifier;
a second transistor having a source connected to the input circuit, a drain connected to the output circuit, a gate that inputs the output from the first differential amplifier, and a current driving capability that is less than the first transistor; and
an overshoot adjusting circuit that turns off the first transistor if the feedback voltage exceeds a predetermined value.

2. The voltage regulator circuit according to claim 1, wherein the overshoot adjusting circuit comprises:
a second differential amplifier that compares a predetermined reference voltage and the feedback voltage;
a control transistor that is connected with the switchable first transistor; and
a switching circuit that switches the control transistor according to an output from the second differential amplifier.

3. The voltage regulator circuit according to claim 2, wherein a differential input terminal of the second differential amplifier inputs a constant voltage generated by a predetermined power supply terminal and the feedback voltage.

4. The voltage regulator circuit according to claim 2, wherein the differential input terminal of the second differential amplifier inputs the reference voltage to be input to the first differential amplifier and a voltage obtained by dividing the feedback voltage by a plurality of resistors.

5. The voltage regulator circuit according to claim 2, wherein the differential input terminal of the second differential amplifier inputs a voltage obtained by dividing the reference voltage to be input to the first differential amplifier by a plurality of resistors and the feedback voltage.
